(19) United States
(12) Patent Application Publication
(10) Pub. No.: US 2026/0303330 A1
(43) Pub. Date: Oct. 1, 2026

(54) PRIVACY-PRESERVING AGGREGATION

(71) Applicant: ROSEMAN GROUP B.V., Breda (NL)

(72) Inventors: Meilof Geert VEENINGEN, Utrecht (NL); Aldo GUNSING, Utrecht (NL)

(21) Appl. No.: 19/472,584

(22) PCT Filed: Apr. 2, 2024
(86) PCT No.: PCT/EP2024/058961

§ 371 Date: Oct. 3, 2025

(30) Foreign Application Priority Data
Apr. 7, 2023 (EP) 23020176.6
Dec. 11, 2023 (EP) 23215564.8

(51) Int. Cl. H04L 9/08; H04L 9/32

(52) U.S. Cl. CPC H04L 9/085; H04L 9/0894; H04L 9/3236; H04L 2209/46

(57) ABSTRACT

The invention relates to a cryptographic system (010) for performing an aggregation of a set of values according to a corresponding set of keys and according to an aggregation operation. The aggregation is performed in a privacy-preserving way as a multi-party computation. The values are obtained as secret values of the multi-party computation, sorted according to the keys. The values are aggregated such that, for each group of distinct key, value pairs, at least one of the aggregate values represents the aggregation of the values. This is done by dividing the set of values into multiple subsets of adjacent values; aggregating adjacent first and second subsets; and combining the aggregated values of the first and second subset by, if the final key of the first subset matches the first key of the second subset, combining aggregate values for the final key and the first key.

### FIELD OF THE INVENTION

The invention relates to cryptographic systems for applying an aggregation and/or duplication to a set of values, using cryptographic secure multi-party computation. The invention further relates to a cryptographic device for use in such a system; to a corresponding computer-implemented method; and to a computer-readable medium.

### BACKGROUND OF THE INVENTION

There is a growing demand for privacy enhancing technologies (PETs), i.e., data processing techniques that intrinsically protect the privacy of the data they operate on. For example, with the cryptographic technique of secure multiparty computation (MPC), multiple parties can perform a computation on their joint input using a distributed cryptographic protocol, such that each party learns nothing beyond the output of computation and his own (private) input.

One reason for the growing demand for PETs is that citizens are becoming increasingly dependent on the digital information stored about them by various companies and institutions. Because of this increasing dependence, the consequences of a breach of personal data are getting increasingly severe. And due to the worldwide surge of cybercrime and nation-state-sponsored cyber espionage, the risk of a data breach has increased sharply in recent years.

Also, data-based collaborations between separate entities (like companies, hospitals, local governments) usually implies that personal data is copied between the entities, which poses the risk of uncontrolled spreading of data, in particular personal information. PETs can enable data collaboration between entities without the need for sharing the data in cleartext form.

Another factor driving demand for PETs is the emergence of legal frameworks for data protection, such as the European GDPR and the Californian CCPA legislation, and their mandatory compliance. In the context of such frameworks, PETs are valuable as technical safeguards, and typically provide concrete instantiations of abstract legal notions.

One important group of functionality for PETs is database-like functionality. That is, respective parties may hold respective tables of data (e.g., numeric and/or textual data), and the PET may be used to perform database-type operations on this data, e.g., concatenation (horizontal and/or vertical), merging, grouping and/or aggregation. There is a need to perform such operations in a privacy-enhancing way as efficiently as possible.

In the paper “Secure Multi-Party Sorting and Applications” by K. Jónsson et al., Cryptology ePrint Archive, paper 2011/122, a technique is presented to perform aggregation of key-value pairs using multi-party computation. This technique is referred to as “Odd-even aggregation”. The technique takes a set of sorted key-values pairs as input. The sequence is modified in-place to contain one key-value pair with non-zero weight for each unique key. This is done by recursively aggregating the odd-indexed elements with index 1, 3, 5, . . . and the even-indexed elements with index 2, 4, 6, . . . ; and then applying a pairwise aggregation operation to pairs of elements (1,2); (2,3); (3,4); . . .

### SUMMARY OF THE INVENTION

It would be desirable to provide cryptographic techniques for privacy-preserving aggregation with improved computational efficiency. In an aggregation operation, a set of values may be aggregated according to a corresponding set of keys. For a set of matching keys with corresponding values, an aggregate value may be computed that represents an aggregation of the values according to an aggregation operation, e.g., the sum, minimum, or maximum. In accordance with a first aspect of the invention, a cryptographic system for performing such an aggregation is provided, as defined by claim 1.

Further, it would be desirable to provide cryptographic techniques for privacy-preserving duplication. In duplication, instead of taking multiple values corresponding to a key and aggregating them into an aggregate value; a value corresponding to one key of a set of matching keys may be duplicated to the other values. This is useful for performing a database merge, for example. In accordance with a second aspect of the invention, a cryptographic system for performing such a duplication is provided, as defined by claim 10.

In accordance with further aspects of the invention, a cryptographic device for use in a cryptographic system for aggregation and/or duplication; and a cryptographic method of performing an aggregation and/or duplication are provided, as defined by claims 13 and 14, respectively. In accordance with an aspect of the invention, a computer-readable medium is provided, as defined by claim 15.

The techniques described herein make use of cryptographic secure multi-party computation (MPC). As is known per se, MPC is a cryptographic technique in which a computation is performed in a distributed way between multiple cryptographic devices in such a way that the inputs, intermediate values, and/or outputs of the computation remain hidden from the parties performing the computation. Such values that remain hidden from the parties may be referred to as the secret values of the MPC. In general, a secret value of the MPC may have the property that a limited number of parties, up to a given threshold, does not know the secret value. However, a number of parties that exceeds the threshold may be able to derive the secret value.

A secret value can for example be a threshold encryption, of which the decryption key is distributed among the parties; or a secret sharing, also referred to herein simply as a sharing. A sharing may be defined as a distributed representation of a value into shares of the respective parties such that a limited number of the shares, up to the given threshold, does not allow to derive the represented value. Although the term “secret share” is most commonly used for MPC techniques using so-called arithmetic secret sharing, also other MPC techniques such as garbled circuits are considered herein to operate on secret shares. In multi-party computation, through the use of secret values and of various protocols that allow to perform operations on secret values, e.g., in secret-shared or threshold encrypted form, various computations can be performed, while keeping the underlying values hidden from the parties that perform them, thus providing privacy-preserving computation. The design of efficient MPC protocols for specific operations is the topic of a significant amount of research.

The techniques herein provide efficient MPC protocols for aggregation and/or duplication. Generally, the aggregation and/or duplication may be performed on a set of value pairs according to a set of corresponding keys. Sets of values with matching keys may be aggregated or duplicated. Here, “matching” may refer to the keys being the same or otherwise equivalent, e.g., equal up to upper/lower case, or up to another equivalence. Conceptually, the aggregation and/or duplication may be applied to a set of key-value pairs, although, in some embodiments, the party that performs the aggregation and/or duplication of the values does not need access to the keys in plain or even in secret form. The aggregation and/or duplication may be performed in such a way that the parties carrying out the operation, do not learn any information about the values and/or keys and/or the number of keys that match, except for the total number of keys and values.

The aggregation and/or duplication may be applied to values that are sorted by key, or, more generally, are ordered such that matching keys are adjacent in the ordering. Thus, according to the ordering, the keys may be partitioned into blocks of matching keys. The inventors envisaged a particularly efficient way of performing aggregation and duplication using MPC on values that are ordered in such a way.

Namely, the inventors envisaged to divide the set of values into multiple adjacent sets of adjacent values. The division may be performed independently of whether the corresponding keys match; indeed, when using MPC, the parties that perform the computation typically do not learn whether this is the case. It is particularly effective to split the set of values into two sets of adjacent values, e.g., to divide the set of values into an upper half and a lower half. In principle, however, also larger numbers of subsets are possible. The aggregation and duplication can then be performed as a divide-and-conquer by either first aggregating (“divide”) the subsets of adjacent values and then combining the result (“conquer”); or by first duplicating to the subsets (“conquer”) and then performing duplication within the subsets (“divide”).

Specifically, for aggregation, the aggregated values of the first and second subset may be aggregated by, if the final key of the first subset matches the first key of the second subset, combining the aggregate values for the final key and the first key. Indeed, if the values are ordered according to matching keys, and the subsets are aggregated, then there may be at most one overlapping group of matching keys between the subsets, namely, the group to which the final key of the first subset and the first key of the second subset belong. Accordingly, an aggregation of the overall set may be obtained by combining the aggregated values corresponding to that final and first key.

Similarly, duplication may be applied by, if the final key of the first subset matches the first key of the second subset, duplicating the value corresponding to their set of keys such that both the first and the second subset comprise the duplicated value. As above, if values are ordered to matching keys, then the final and first key may match, and in this case, a value may be duplicated from the first subset to the second subset, or the other way round. After this, duplication can be applied separately to the two subsets.

Interestingly, the above divide-and-conquer approach is computationally efficient, because at higher levels of the divide-and-conquer, a relatively simple “conquer” step can be performed that scales only in the number of subsets; for example, at the highest level, only two subsets may need to be aggregated/duplicated; at the first level of recursion, only four subsets may need to be aggregated/duplicated; etc. In particular, the “conquer” step may not scale in the overall number of values to be aggregated/duplicated. E.g., the number of times that pairs of keys need to be checked for equality/matching, and/or the number of times that the aggregation operation (e.g., plus, max, min) needs to be applied at a certain recursion depth, may be independent from the overall number of values to be aggregated/duplicated, and may thus be greatly reduced.

In particular, the respective divide operations of the divide-and-conquer may use only the first and last values of the respective subsets. This results in a particularly efficient overall solution because a limited amount of data and operations is needed. For example, at the highest level of the divide-and-conquer, the conquer step of the aggregation may act only on the first and last values of the (two or more) subsets. Similarly, the conquer step of the duplication may act only on the first and last values of the (two or more) subsets.

A further advantage of the provided approach is that it can be implemented efficiently in a vectorized way, e.g., by applying operations, e.g., addition and multiplication, to multiple values at the same time. For example, when using the first and last values of respective subsets, a round of the divide-and-conquer may operate on one or more subsets of the set of values that have a fixed stride in the overall set, e.g., the top values of respective first subsets; the bottom values of first subsets; the top values of second subsets; and the bottom values of second subsets. These sets may be referred to by respective starting indices and a common stride, corresponding to the size of the subsets. This greatly facilitates a vectorized implementation e.g. using a strided iterator.

Generally, the aggregation can be performed according to various aggregation operations. For example, the aggregation operation can be a sum; a maximum; a minimum; or any other associative operation. When applied to a set of respective private values, the result may be a set of respective private aggregate values. For a set of matching keys K, at least one of the aggregate values v∈Vcorresponding to a key k∈K, may represent an aggregation of the values V corresponding to the matching keys K according to the aggregation operation. For the duplication, when applied to a set of values V, the value v∈V corresponding to one key k∈K of a group of matching keys K, may be duplicated to the values V corresponding to the other matching keys K. In both cases, which aggregate value represents the aggregation or which value is duplicated, can be indicated by a result indicator, as discussed in more detail elsewhere in this specification.

Optionally, the aggregation can be performed on a set of values such that, if the first key and the final key of the set do not match, then the first aggregate value and the final aggregate value of the set represent the aggregations for the first and final keys. If all keys of the set match, then the first and/or final aggregate value may represent the aggregation of the set of values. This facilitates an efficient “conquer” step of the divide-and-conquer by facilitating an aggregation that only uses the first and final aggregate values of subsets. A particularly efficient aggregation is possible when the aggregation is performed such that, if all keys of the set match, then the first and final aggregate value both represent the aggregation of the set of values. In this case, when combining aggregated values of two subsets, it may suffice to apply the aggregation operation to the final aggregated value of the first subset and the first aggregated value of the second subset. This is beneficial especially if the aggregation operation is relatively expensive to compute under MPC, such as when the aggregation operation is based on a numeric comparison, e.g., a maximum or minimum.

Optionally, the duplication may be applied to a set of values such that, if the first key and the final key of the set do not match, then the first value and the final value of the set are duplicated to their respective other keys. If the first key and the final key of the set match, then the first value or the final value of the set may be duplicated to the set of values. Interestingly, the “conquer” step of duplication can satisfy this invariant relatively efficiently, namely, by manipulating only the first and final values of the subsets to which the “divide” step of the duplication is applied.

Optionally, prior to performing the aggregation and/or duplication, the respective values may be sorted under the secure multi-party computation. This way, the values may be ordered such that matching keys are adjacent in the ordering. However, it is not necessary to perform sorting under multi-party computation, e.g., a party that provides the values as input, may provide them already ordered according to the set of keys.

Optionally, to order the values such that the matching keys are adjacent in the ordering, respective keys may be transformed into respective transformed keys, coming from a smaller range than the keys themselves. The values may then be sorted according to the respective transformed keys. Namely, the inventors realized that, for the purpose of aggregation and duplication, the values may not need to be sorted according to any particular ordering. Thus, it may suffice to transform the keys according to any kind of transformation; and then sort, or otherwise order, the transformed keys. By selecting transformed keys from a smaller range, this latter ordering can be performed more efficiently than on the ordinal keys. In particular, various known techniques for sorting, scale linearly or worse in the bit length of the inputs. By sorting on a transformed key that is smaller than the original key, e.g., has at most a quarter or at most half of the bit length, performance can thus be greatly improved.

In general, the transformation can be performed in various ways. For example, the transformation may comprise computing a linear combination of multiple subkeys comprised in a respective key, e.g., of multiple elementary values that make up the key. For example, a subkey may be a character of a text string, an element of a numeric vector, etc. A linear combination is advantageous since it can be computed under multi-party computation particularly efficiently. In particular, by selecting sufficiently large random coefficients, the probability of multiple keys resulting the same linear combination can be made as small as desired.

Instead of or in addition to using a linear combination, a hash function may be applied. For example, the hash function may be applied to the result of the linear combination. Interestingly, when a hash function is used, the probability that multiple keys result in the same transformed key, may dependent only on the number of unique hash inputs, and not on the particular keys that are input to it. Because the collision probability does not depend on the data, it is possible to verify that the values are ordered such that the matching keys are adjacent in the ordering, and to let the cryptographic devices learn the verification result, without this verification leaking additional information about the underlying data. As a consequence, it may be possible to securely use a hash function that has a relatively small range, e.g., of at most 10 bits, at most 30 bits, or at most 50 bits. If the verification is not successful, for example, an error can be raised, or the hashes, and optionally also the linear combinations, can be re-computed and re-ordered, e.g., with different coefficients of the linear combination and/or a different key for the (in this case, keyed) hash. Thereby, efficiency on average can be greatly increased at the expense of, in some cases, having to perform the re-computation and the re-ordering.

Optionally, the aggregation and/or duplication may be performed using precomputation data that is determined before performing the aggregation and/or duplication. This precomputation data may optionally be computed as a multi-party computation, but it can also for example be provided as an input by an input party of the multi-party computation.

When performing a “conquer” step of aggregation or duplication for two adjacent subsets of adjacent values, the precomputation data may comprise a match indicator indicating if the final key of the first subset matches the first key of the second subset. The match indicator may be private. By using the matching indicator, it can be avoided to compute the match indicator at the time of the aggregation or duplication, making this operation per se faster. By precomputation, latency between providing the value as input and obtaining the aggregation/duplication as output, can be reduced, and efficiency can be improved by using the precomputation data in multiple aggregations/duplications.

Optionally, the match indicators(s) can be computed using multi-party computation, either before or during the aggregation/duplication. Interestingly, a match indicator may be computed by performing pairwise comparisons of adjacent keys, and combining the pairwise comparisons. This is particularly advantageous because, when using multi-party computation, it is typically much more efficient to combine comparisons using Boolean logic than to compute them. Indeed, the latter is often implemented using a relatively costly cryptographic protocol. In particular, the match indicators used for aggregation/duplication may be computed based on pairwise comparisons just of adjacent keys, and in particular, a linear number of comparisons between keys may suffice.

Optionally, the precomputation data may comprise result indicators indicating which aggregate values represent an aggregation. For example, a respective result indicator may indicate for a respective value whether or not the corresponding aggregation value, after performing aggregation, represents an aggregation. The result indicators may be private, e.g., may be respective private bits corresponding to respective values. The result indicators can be used to, after aggregating, filter the aggregate values according to the result indicators. This way, aggregation values that represent aggregations may be filtered from aggregation values that do not represent aggregations. The filtering can for example be performed by zeroing out the filtered-out values, or by outputting a filtered set that contains only the filtered values. For this, techniques are known per se.

The result indicators may instead or in addition indicate which values are duplicated to other matching keys by the duplication described herein. More generally, the positions at which the aggregation places aggregations, may be the same as the positions that the duplication duplicates. This is advantageous not only because the same result indicators can be used, but also because it allows e.g. to first aggregate a set of input values and then applying the duplication to the aggregate values, thereby obtaining respective aggregates corresponding to the respective input values.

Optionally, the precomputation data may further comprise data representing a permutation to order the respective values according to the ordering. The permutation can be represented privately using various known representations, e.g., as control bits for one or more Waksman permutation networks; as respective permutations to be sequentially applied; etc. The permutation data can be used to efficiently order an original set of input values according to the ordering, e.g., without needing to perform comparisons between keys at that point. The permutation data can also be used to apply the inverse permutation to values to which aggregation or duplication has been applied as described herein. This way, the resulting aggregate values or duplicated values can be efficiently put in the order of the original input values, which is useful e.g. for a database merge operation.

It is noted that the ordering can be determined before performing the aggregation or duplication, and in particular, before having access to the values to be aggregated or duplicated. As discussed, the ordering can be determined under MPC, e.g., by sorting the keys; or it can be input by an input party into the MPC, etc.

Optionally, a merge may be performed of a first table and a second table. The merge may be performed on a first column of the first table and on a second column of the second table. A merge is also referred to, e.g., in SQL, as a join. The merge may match values of the first column and second column, and may result in a table with respective rows for the respective matches. Depending on the type of join, rows from the left table (for a left join or outer join) or from the right table (for a right join or outer join) that do not have a matching row in the other table, may also be included. Interestingly, a join wherein the first column contains duplicates, can be implemented efficiently using the duplication operation provided herein. Namely, values coming from a further column of the second table may be duplicated according to the column containing the duplicates. By combining such a duplication with a join on the unique values of the first column, respective values of the further column, corresponding to the respective values of the first column, can be obtained. This way, this important database operation can be implemented efficiently.

It will be appreciated by those skilled in the art that two or more of the above-mentioned embodiments, implementations, and/or optional aspects of the invention may be combined in any way deemed useful.

Modifications and variations of any system and/or any computer readable medium, which correspond to the described modifications and variations of a corresponding computer-implemented method, can be carried out by a person skilled in the art on the basis of the present description, and the other way round as well.

### BRIEF DESCRIPTION OF THE DRAWINGS

These and other aspects of the invention will be apparent from and elucidated further with reference to the embodiments described by way of example in the following description and with reference to the accompanying drawings, in which:

FIG. 1 shows a cryptographic device;

FIG. 2 shows a cryptographic device;

FIG. 3 shows a cryptographic system;

FIG. 4 shows a detailed example of dividing a set into adjacent values;

FIG. 5 shows a detailed example of how to determine precomputation data;

FIG. 6 shows a detailed example of how to aggregate a set of values;

FIG. 7 shows a detailed example of how to apply a duplication to values;

FIG. 8 shows a detailed example of how to aggregate a set of values;

FIG. 9 shows a detailed example of how to perform a merge of tables;

FIG. 10 shows a computer-implemented method;

FIG. 11 shows a computer-readable medium comprising data;

FIG. 12 shows a detailed example of how to order a set of values.

It should be noted that the figures are purely diagrammatic and not drawn to scale. In the figures, elements which correspond to elements already described may have the same reference numerals.

### DETAILED DESCRIPTION OF EMBODIMENTS

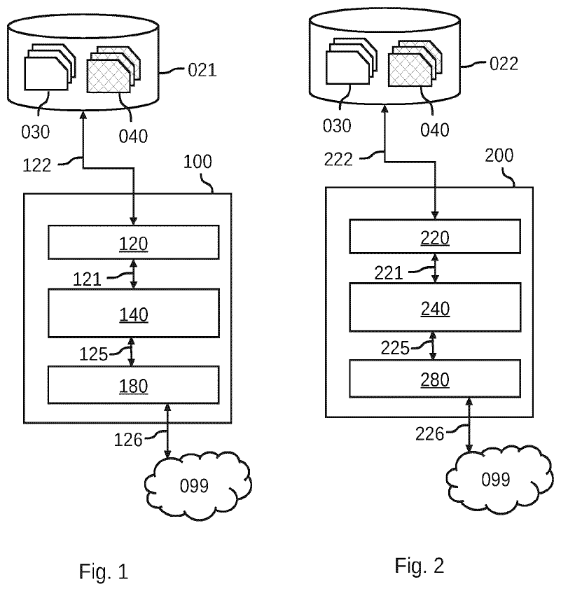

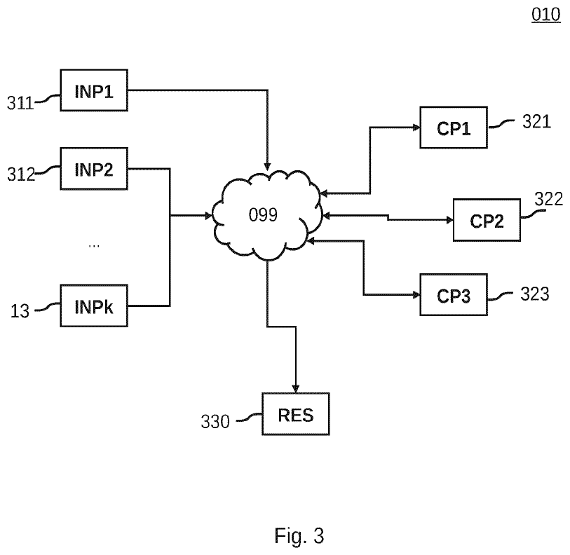

FIG. 1 shows a cryptographic device 100 for use in a cryptographic system as described herein, e.g., in FIG. 3. The cryptographic system may be for performing an aggregation of a set of values according to a corresponding set of keys and according to an aggregation operation, such as computing the sum, minimum, or maximum. The aggregation may be performed in a privacy-preserving way as a cryptographic secure multi-party computation (MPC) between multiple cryptographic devices, including device 100.

The device 100 may comprise a data interface 120 for accessing data 030 representing values as private values of the MPC. The respective values 030 may be ordered such that matching keys are adjacent in the ordering. The data interface 120 may be for further accessing data 040 representing the respective keys as private values of the MPC, and/or pre-processing material for performing the aggregation. For example, the number of values can be at most or at least 1000, at most or at least 10000, or at most or at least 1000000. The keys and values can in general have various types, e.g., can be numeric data (e.g., integral, fixed-point, or floating point), textual, etc. In general, a respective value may be represented as private representations, e.g., secret-shares, of one or more elementary values of the multi-party computation system, e.g., field elements (for Shamir secret sharing); ring elements (for replicated secret sharing); bits (for garbled circuits); etc.

For example, as also illustrated in FIG. 1, the input interface may be constituted by a data storage interface 120 which may access the data 030, 040 from a data storage 021. For example, the data storage interface 120 may be a memory interface or a persistent storage interface, e.g., a hard disk or an SSD interface, but also a personal, local, or wide area network interface such as a Bluetooth, Zigbee or Wi-Fi interface or an ethernet or fibreoptic interface. The data storage 021 may be an internal data storage of the system 100, such as a hard drive or SSD, but also an external data storage, e.g., a network-accessible data storage. In some embodiments, the data 030, 040 may each be accessed from or distributed across different data storages, e.g., via a different subsystem of the data storage interface 120. Each subsystem may be of a type as is described above for data storage interface 120.

The device 100 may further comprise a processor subsystem 140 which may be configured to, during operation of the system 100, obtain the representations 030 of the respective values. The respective values may be ordered such that matching keys 040 are adjacent in the ordering. The processor subsystem 140 may be configured to aggregate the set of respective values to compute the respective aggregate values in private form. For a set of multiple matching keys 040, at least one of the corresponding aggregate values 030 may represent an aggregation according to the aggregation operation of the set of values 030 corresponding to the set of matching keys 040. The aggregating may be performed by: dividing the set of values into multiple subsets of adjacent values; aggregating adjacent first and second subsets; and combining the aggregated values of the first and second subset by, if the final key of the first subset matches the first key of the second subset, combining aggregate values for the final key and the first key.

As also discussed with respect to FIG. 3, the device 100 may be further configured to provide inputs to the multi-party computation, e.g., to obtain the values 030 and/or keys in plain form and input them to the multi-party computation, e.g. by secret-sharing, encrypting, or otherwise masking them. Instead or in addition, the device 100 may be further configured to obtain outputs from the multi-party computation, e.g., to obtain the aggregate values or filtered aggregate values, e.g., by receiving one or more secret shares and recombining the outputs from these secret shares.

The system 100 may also comprise a communication interface 180 configured for communication 126 with at least one further cryptographic device of the cryptographic system. Communication interface 180 may internally communicate with processor subsystem 140 via data communication 125. Communication interface 180 may be arranged for direct communication with the other devices, e.g., using USB, IEEE 1394, or similar interfaces. As illustrated in the figure, communication interface 180 may also communicate over a computer network 099, for example, a wireless personal area network, an internet, an intranet, a LAN, a WLAN, etc. For instance, communication interface 180 may comprise a connector, e.g., a wireless connector, an Ethernet connector, a Wi-Fi, 4G or 4G antenna, a ZigBee chip, etc., as appropriate for the computer network. Communication interface 180 may be an internal communication interface, e.g., a bus, an API, a storage interface, etc.

FIG. 2 shows a cryptographic device 200 for use in a cryptographic system as described herein, e.g., in FIG. 3. The cryptographic system may be for applying a duplication to a set of values according to a set of keys. The duplication may be performed in a privacy-preserving way as a cryptographic secure multi-party computation (MPC) between multiple cryptographic devices, including device 200.

In general, the device 200 may be as described for device 100 of FIG. 1. In particular, device 200 may comprise a data interface 220, a processor subsystem 240, and/or a communication interface 280, for which the same options are available as discussed for cryptographic device 100 of FIG. 1. It is also possible to combine devices 100 and 200, e.g., a single cryptographic device may be configured to perform both aggregation and duplication, on the same or different data and according to the same or different keys.

In particular, the cryptographic device 200 may comprise a data interface 220. The data interface may be for accessing data 030 representing the respective values as private values of the MPC. The respective values may be ordered such that matching keys are adjacent in the ordering. The data interface 220 may be further for accessing data 040 representing the respective keys as private values of the MPC, and/or for accessing precomputation material. The keys and values can be as discussed for FIG. 1.

Processor subsystem 240 may be configured to apply the duplication to the set of respective values 030. For a set of multiple matching keys 040, processor subsystem 240 may be configured to duplicate a value 030 corresponding to a matching key 040 to the values 030 corresponding to the other matching keys 040. To this end, processor subsystem 240 may be configured to divide the set of values into multiple subsets of adjacent values; for a first and second adjacent subset, if the final key of the first subset matches the first key of the second subset, duplicate the value corresponding to their set of keys such that both the first and the second subset comprise the duplicated value; and apply the duplication to the first and second subsets of values. Similarly to device 100 of FIG. 1, device 200 may be configured to provide input to and/or receive output from the multi-party computation.

In general, each device described in this specification, including but not limited to the system 100 of FIG. 1 and the system 200 of FIG. 2, may be embodied as, or in, a single device or apparatus, such as a workstation or a server. The device may be an embedded device. The device or apparatus may comprise one or more microprocessors which execute appropriate software. For example, the processor subsystem of the respective system may be embodied by a single Central Processing Unit (CPU), but also by a combination or system of such CPUs and/or other types of processing units. The software may have been downloaded and/or stored in a corresponding memory, e.g., a volatile memory such as RAM or a non-volatile memory such as Flash. Alternatively, the processor subsystem of the respective system may be implemented in the device or apparatus in the form of programmable logic, e.g., as a Field-Programmable Gate Array (FPGA). In general, each functional unit of the respective system may be implemented in the form of a circuit. The respective system may also be implemented in a distributed manner, e.g., involving different devices or apparatuses, such as distributed local or cloud-based servers.

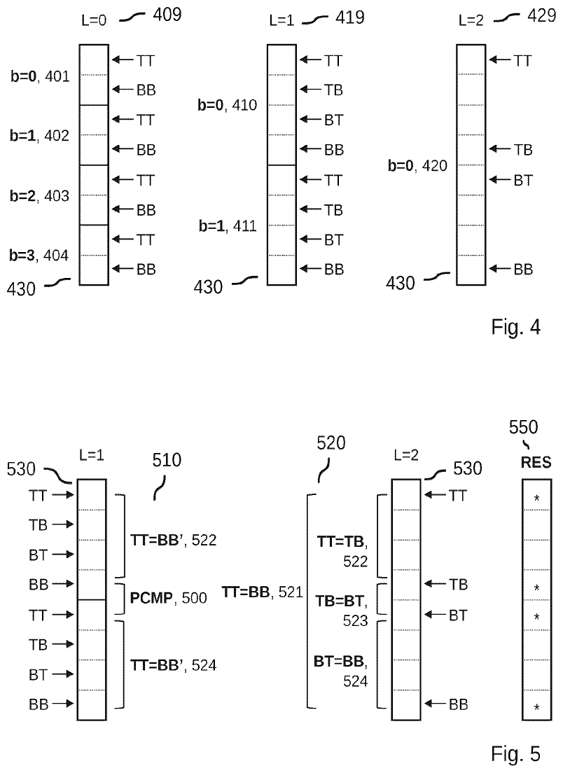

FIG. 3 shows a cryptographic system 010 for applying an aggregation and/or a duplication to a set of values. The aggregation and/or duplication may be performed in a privacy-preserving way as a cryptographic secure multi-party computation between multiple cryptographic devices, e.g., as described with respect to FIG. 4-FIG. 9. The cryptographic system 010 may in general comprise multiple input devices, multiple different cryptographic devices, and at least one result device, where the sets of input, cryptographic, and result devices may overlap with each other. As illustrated, the devices typically communicate over a computer network 099, e.g., the internet or a local network.

In particular, shown in the figure are three cryptographic devices CP1, 201; CP2, 202; and CP3, 203. The cryptographic devices may be based on cryptographic device 100 of FIG. 1 or cryptographic device 200 of FIG. 2. The number of cryptographic devices that is used can vary depending on the particular technique used for the multi-party computation and the security properties which are desired. For example, the number of cryptographic devices CPi can be two, three, or more.

The cryptographic devices CPi may be configured to perform a secure multi-party computation (also known per se as multi-party computation, secure computation, or MPC). Generally, a multi-party computation may be a distributed protocol between the cryptographic devices for performing a computation in a privacy-preserving way. Depending on the specific technique used, MPC may ensure privacy and/or correctness of the computation against an attacker that eavesdrops or controls one or more (but typically not all) of the cryptographic devices. As known per se, any computation can be performed as a multi-party computation (in other words, “under the multi-party computation”), but concrete computational and communication efficiency can in general greatly depend on how exactly the computation is performed.

In particular, the multi-party computation can be performed based on one of the following techniques:
based on secret sharing, in particular arithmetic secret sharing such as Shamir secret sharing, replicated secret sharing, or additive secret sharing. For example, the multi-party computation can be based on the techniques described in Shamir, “How to Share a Secret”, Communications ACM, 1979; Ben-Or, Goldwasser, Wigderson, “Completeness Theorems for Non-Cryptographic Fault-Tolerant Distributed Computation (Extended Abstract)”, Proceedings of the 20th Annual ACM Symposium on Theory of Computing, 1988; Chaum, Crepeau, Damgaard, “Multiparty Unconditionally Secure Protocols (Extended Abstract)”, Proceedings of the 20th Annual ACM Symposium on Theory of Computing, 1988; Ito, Saito, Nishizeki, “Secret sharing scheme realizing general access structure”, Electronics and Communications in Japan (Part III: Fundamental Electronic Science), 1989; Damgaard, Pastro, Smart, Zakarias, “Multiparty Computation from Somewhat Homomorphic Encryption”, proceedings CRYPTO 2012;
based on garbled circuits, e.g., see Yao, “Protocols for Secure Computations (Extended Abstract)”, 23rd Annual Symposium on Foundations of Computer Science, Chicago, 1982;
based on oblivious transfer, e.g., see Goldreich, Micali, Wigderson, “How to Play any Mental Game or A Completeness Theorem for Protocols with Honest Majority”, Proceedings of the 19th Annual ACM Symposium on Theory of Computing, 1987;
based on threshold homomorphic encryption, e.g., see Cramer, Damgaard, Nielsen, “Multiparty Computation from Threshold Homomorphic Encryption”, proceedings EUROCRYPT 2001;
based on any combination of the above, e.g., see Demmler, Schneider, Zohner, “ABY-A Framework for Efficient Mixed-Protocol Secure Two-Party Computation”, proceedings NDSS 2015.

Various higher-level operations such as sorting and integer comparison can be performed based on such basic multi-party computation protocols as discussed e.g. in M. Keller, “MP-SPDZ: A Versatile Framework for Multi-Party Computation”, proceedings ACM CCS 2020; or as implemented in MPyC, see https://github.com/lschoe/mpyc.

The multi-party computation may be configured to perform operations on so called sharings, or secret shares, of values. A secret share may be a distributed representation of an input, intermediate, or output value of the MPC. A limited number of shares, up to a certain threshold T, may not allow to derive the represented value. The threshold may be configurable, with different techniques supporting different possible threshold. For example, the multi-party computation may be an honest majority MPC, where the threshold T is strictly smaller than the number of parties N, e.g., N=2T+1. Or, the multi-party computation can be a full-threshold MPC, where the threshold can be higher, e.g., T=N−1. Examples of sharings are arithmetic sharing, such as Shamir secret sharing or replicated secret sharing; XOR sharing; or Yao sharing. It is stressed that the term secret sharing in this specification also includes Yao sharings, e.g., secret values of an MPC computation performed using garbled circuits, as also done in “ABY-A Framework for Efficient Mixed-Protocol Secure Two-Party Computation”.

A value that is computed on by the MPC but that is represented among the parties in such a way that no single party, more generally no unqualified set of parties, can derive the value from that representation, is referred to as a secret value, or private value, of the MPC. A secret value can be a secret sharing, but it is also possible e.g. to use a threshold encryption. For example, a secret value can be a secret input, a secret output, or a secret intermediate value. Here, a secret input may be known in the plain by the party inputting it, and known only in a secret representation by the cryptographic devices CPi; and similarly, a secret output may be learned in the plain by the party receiving it as output, but may be known only in a secret representation by the cryptographic devices CPi. A private intermediate value may be known only to the cryptographic devices CPi, and only as a secret representation. By processing values using secret representations, the data can be kept secret, at least as long as the underlying assumptions of the multi-party computations (e.g., in terms of the number and/or type of corruptions of the cryptographic devices) are satisfied.

Also shown in the figure are a number of input devices INP1, 101; INP2, 102; up to INPk, 103. The input devices may input the keys and/or values to which an aggregation of duplication is performed, or data from which these keys and values are computed under MPC, e.g., by performing one or more database operations on the input under MPC. When using precomputation data as described herein, an input device may be configured to determine the precomputation data, e.g., to determine match indicators and/or result indicators for respective keys, and/or to determine a permutation to order values according an ordering of the keys as described herein; and to provide such precomputation data as an input to the multi-party computation.

The input devices 101-103 may use the hardware configuration discussed in FIG. 1. The number of input devices can be two, at most or at least three, or at most or at least five, for example. In many cases, the sets of inputs devices INPi and cryptographic devices CPi may wholly or partially overlap. For example, the set of input devices may be a subset or a superset of the set of cryptographic devices, or may be exactly the same.

Further shown is a result device RES. The result device RES may obtain a result of the MPC based on a computed aggregation and/or duplication. For example, the result device RES may obtain one or more of the aggregate values; one or more of the values to which duplication is applied; or other values based on this. For example, the duplication may be used in a database merge, and the result device RES may learn the result of the merge; an aggregate derived from the merged table; etc. It is also possible for multiple respective result devices to obtain multiple respective results of the multi-party computation based on the performed aggregation and/or duplication. Although illustrated as a separate device in the figure, the result device(s) RES can be the same devices as an input device INPi and/or cryptographic device CPi. Generally, the result device may be implemented using the hardware configuration discussed with respect to FIG. 1.

Many known multi-party computation techniques are defined per se for the case where the input and result devices INPi and RES form a subset of the set of cryptographic devices CPi that perform the MPC. To use such techniques in a setting where an input and/or result device does not perform the MPC itself, an input device can for example determine a secret representation, e.g., a secret sharing, and distribute it among the computation devices. Similarly, a result device can for example receive a secret representation, e.g., respective secret shares, of an output from the computation devices and derive the output from the secret representation. It is also possible to use specific techniques for letting an external party provide inputs to and/or obtain outputs from a multi-party computation. For example, the techniques from the following reference can be used: T. P. Jakobsen, J. B. Nielsen, and C. Orlandi. “A framework for outsourcing of secure computation”, proceedings CCSW′14.

FIG. 4 shows a detailed, yet non-limiting, example of dividing a set into subsets of adjacent values. According to the techniques described herein, aggregation and/or duplication may be performed using a divide-and-conquer approach. In particular, at a level of the divide-and-conquer, a set of values may be divided into multiple adjacent sets of adjacent values. The values are preferably split into two halves

This is illustrated in this figure for a set 430 of 8 values. For ease of exposition, examples are used where the number of values is a power of two; but the provided techniques generalize straightforwardly to other numbers.

At the highest level, L=2, 429, the set of values 430 may be represented by a single block, b=0, 420, in this case of size 8. This block has a top-top (TT) element; a top-bottom element (TB); a bottom-top element (BT); and a bottom-bottom (BB) element.

At the next level, L=1, 419, the respective blocks of level L=2 may be divided into two subsets, giving two blocks b=0, 410 and b=1, 411, in this case of size 4. The top-top (TT) elements of this level are the TT and BT elements of level L=2. The bottom-bottom (BB) elements of this level are the TB and BB elements of level L=2. Furthermore, the blocks have respective top-bottom (TB) and bottom-top (BT) elements.

At the lowest level, L=0, 409, the respective blocks of level L=1 may be respectively divided into two subsets, giving two blocks b=0, 401 and b=1, 402, for block 410; and two blocks b=2, 403 and b=3, 404 for block 411. At the lowest level, there are top-top (TT) elements corresponding to the TT and BT elements of one level higher; and bottom-bottom (BB) elements corresponding to the TB and BB elements of one level higher.

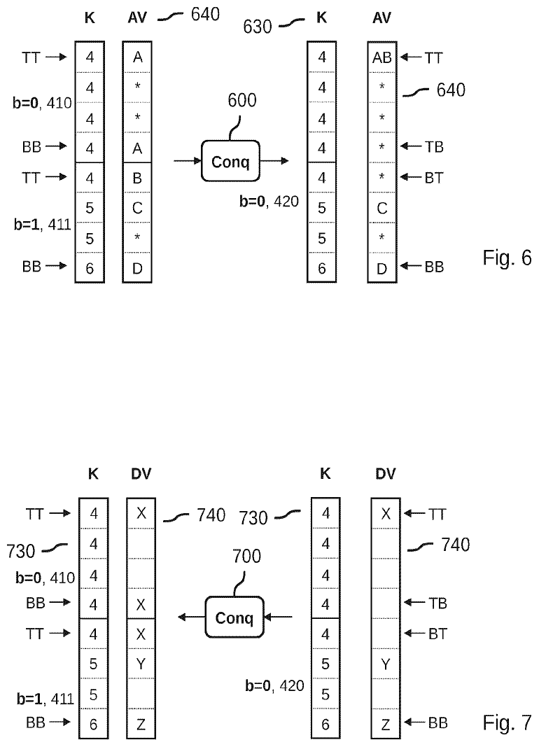

Looking forward to FIGS. 6 and 7, aggregation may be performed by going up the levels 409, 419, 429 using divide-and-conquer, where the TT, TB, BT, and BB elements of a level may be determined from the TT and BB elements at a higher level. It is noted that, for higher levels, the number of elements involved is much smaller than the total number of elements, leading to an efficient aggregation. Further, the respective TT, TB, BT, BB elements have a fixed stride, e.g., respective BT elements at level L=1 are at indices 2, 6, . . . , having stride 4. This allows an effective vectorized implementation.

Similarly, duplication may be performed by going down the levels 429, 419, 409 using divide-and-conquer, where TT, TB, BT, BTT elements of a level may be determined from the TT, TB, BT, and BB elements of the next level. This has the same advantages as for aggregation, namely, that the computation for higher levels is relatively efficient, and that an effective vectorized implementation is possible.

FIG. 5 shows a detailed, yet non-limiting, example of how to determine precomputation data. As also discussed elsewhere, the aggregation and duplication operations described herein can make use of such information. In particular, this information may comprise match indicators indicating if respective keys match. Further, this information may comprise result indicators indicating which aggregated values represent the results of the aggregation, and/or which values are duplicated by the duplication. Interestingly, both kinds of information can be computed before the aggregation and duplication is performed and/or re-used between such operations—although this is not strictly needed, and it is also possible to compute this information as the operation is performed.

The precomputation data can be computed in the plain, e.g., without the use of MPC, by a party holding the keys. However, interestingly, it is also possible to compute the precomputation data under MPC, based on secret representations of the keys. Here, the keys are assumed to be ordered such that matching, e.g., equal, keys, are adjacent. For example, the keys may be sorted. The precomputation data can also contain data indicating how to get the keys, and corresponding values, in this ordering, as discussed w.r.t. FIG. 9.

When determining the precomputation data under MPC, it is advantageous to determine the precomputation data by performing pairwise comparisons of adjacent keys, and then combining the pairwise comparisons in a divide-and-conquer fashion. This is because, under MPC, it may be relatively expensive to perform comparisons, whereas it may be relatively inexpensive to combine comparison results. For example, to perform comparisons, the equality protocol discussed in “Multiparty Computation for Interval, Equality, and Comparison without Bit-Decomposition Protocol” by T. Nishide and K. Ohta may be used, which is relatively expensive. To combine comparison results using Boolean logic, their logical AND and OR can be computed efficiently by performing the simple arithmetic operations x, y→x·y, x, y→x+y−x·y.

It is now shown how precomputation data 520, 550 at a given level of the divide-and-conquer, in this example, L=2, can be computed from precomputation data 510 at the previous level, in this example, L=1, and from pairwise comparisons of adjacent keys. In this example, the precomputation data at level L=2 comprises match indicators TT=BB, 521; TT=TB, 522; TB=BT; 523; and BT=BB, 524, for the single block b=0, 420, at this level. Match indicators may indicate whether the respective keys of the block, e.g., the top-top (TT) and top-bottom (TB) keys for TB=BT, are equal or otherwise match. This precomputation data for a block 420 may be determined from the corresponding match indicators TT=BB′, 524, 524′ of the two subblocks b=0, 410 and b=1, 411 at the previous level; and from the pairwise comparison PCMP, 500, of the top-bottom and bottom-top elements of the block. E.g., TT=TB and BT=BB may correspond to the TT=BB′ indicators of the sub-blocks, and TB=BT may correspond to the pairwise comparison. TT=BB may be computed as the logical AND of TT=TB, TB=BT, and BT=BB.

This example further shows respective result indicators RES, 550, at level 520, indicating which respective aggregate values contain valid aggregations after aggregation, and/or which respective values are duplicated by the duplication. Also these result indicators may be determined based on the match indicators at the current and previous level. There are several possibilities for the exact way in which the result indicators can be computed, depending on how exactly the “conquer” step of the divide-and-conquer is implemented. In one example, the top-top result indicator is set to true and the bottom-bottom result indicator is set to true unless TT=BB, or the other way round; the top-bottom or bottom-top result indicator is computed based on the match indicators; and the final result indicator is computed such that the sum of the match and result indicators is four.

The following pseudocode implementation illustrates a computation of match and result indicators. When using multi-party computation, the values in italic may be secret. The values that are not in italic may be plain values known to the cryptographic devices carrying out the multi-party computations.

```
def preprocess(keys):
  // perform pairwise comparisons of adjacent keys
  pcmp = (keys[0]==keys[1], keys[1]==keys [2], ...)
  // initialize top-equals-bottom, result indicator for level 0
```

| | |
|---|---|
| tt_eq_bb[0] = (pcmp[0], pcmp[2], ...) | // match indicators |
| results = (1, 1-pcmp[0], 1, 1-pcmp[2], ...) | // result indicators |

```
  for level = 1, 2, ...; blocksize = 4, 8, ...
    for block = 0, 1, ... // tt, tb, bt, bt: indices of top-top, top-bottom, ... elements
      // compute match indicators
      tt_eq_tb[level][block] = tt_eq_bb[level −1][block*2]
      tb_eq_bt[level][block] = pcmp[tb]
      bt_eq_bb[level][block] = tt_eq_bb[level −1][block*2+1]
      tt_eq_bb[level][block] = tt_eq_tb[level][block] ∧ tt_eq_tb[level][block] ∧
        tt_eq_tb[level][block]
      // compute result indicators
      results[bb] = 1− tt_eq_bb[level][block]
      results[bt] = (1−bt_eq_bb[level][block]) * (1− tb_eq_bt[level][block])
      results[tb] = 4 − tt_eq_tb[level][block] − tb_eq_bt[level][block] −
        bt_eq_bb[level][block] − results[tt] − results[bt] − tt_eq_bb[level][block]
  preprocessing_data = (tt_eq_tb, tb_eq_bt, bt_eq_bb, tt_eq_bb, results)
  return precomputation_data
```

FIG. 6 shows a detailed, yet non-limiting, example of how to aggregate a set of values using secure multi-party computation. As discussed e.g. with respect to FIG. 4, aggregation may be performed according to a divide-and-conquer approach. This figure illustrates a conquer step Conq, 600, in which aggregated values of two adjacent subsets may be combined. Specifically, with reference to FIG. 4, the figure shows how aggregated values of subsets b=0, 410; and b=1; 411 may be combined to obtain aggregated values of set b=0, 420. The conquer step Conq in this case updates the aggregated values AV, 640, corresponding to a set of key K, 630, in-place. The values to be aggregated may be ordered such that matching keys are adjacent. For example, the figure shows five keys K labelled “4”, followed by two keys labelled “5”, followed by one key labelled “6”. While the figure shows the values, it will be understood that, in an actual implementation using MPC, these values are secret and so remain hidden to the parties carrying out the computation.

In this example, as shown, the top-top (TT), top-bottom (TB), and bottom-top (BT) key values K match, but are different from the bottom-bottom (BB) value. The conquer step Conq may update the TT, TB, BT, and/or BB values, while preserving the invariant that, for a set of multiple matching keys K, at least one of the corresponding aggregate values AV represents an aggregation according to the aggregation operation of the set of values corresponding to the set of matching keys. For example, for a key among the TT, TB, BT, and BB keys, at least one of the TT, TB, BT, and BB values represents the aggregation.

In particular, if the TB and BT keys match, such as in this example, the conquer step Conq may combine an aggregate value that represents the aggregation for subset 410 with an aggregation value that represents the aggregation for subset 411, to obtain an aggregation value that represents the aggregation for set 420.

In particular, the aggregation may preserve the invariant that, if the TT key and the BB key of a block do not match, then the TT aggregate value and the BB aggregate value represent the aggregations. In this example, block 411 has TT and BB keys “4” and “6”, which do not match, so as a precondition of the conquer step Conq, the TT and BB values “B” and “D” may be the aggregates corresponding to these keys. Similarly, block 420 has TT and BB keys “4” and “6”, which do not match, so as a postcondition of the conquer step Conq, the TT and BB values “AB” and “D” may be the aggregates corresponding to these keys.

The aggregation may further preserve the invariant that, if the TT and BB key of a block match (and so, all keys match because of their adjacent ordering), then the TT and/or BB aggregate value represents the aggregation of the values of the block. For example, for block 410, the TT and BB keys are both “4”, so as a precondition, the TT and/or BB values may contain the aggregation for this key. In particular, it is beneficial to keep the invariant that, in this case, both the TT and the BB values contain the aggregated value “A”, as shown in this figure. This may imply that, whether or not the TT key matches the BB key, the TT and BB values both contain the correct aggregate.

Conquer step Conq may be implemented such that it preserves the above-discussed invariants. Interestingly, this can be done by just updating the TT, TB, BT, and BB values of the block. Also, only a single application of the aggregation operation may suffice. In particular, if it is guaranteed that both the TT and the BB values of a block contain the correct aggregate, then an aggregation may be applied to the TB and BT elements of the resulting block, e.g., the BB and TT elements of the input blocks, and written to the appropriate TT/TB/BT/BB aggregate value AV, depending on whether the TT, TB, BT, and BB keys K match.

As will be realized, there are various ways of implementing the conquer step Conq of the divide-and-conquer in such a way that only the top-top and bottom-bottom elements at the previous level (corresponding to the top-top, top-bottom, bottom-top, and bottom-bottom elements of the present level) are updated. The same also holds when combining more than two sub-blocks.

In particular, in the example shown, the value “A” of the TB element and the value “B” of the BT element may be aggregated and, in this case, written to the top-top element of the resulting block. Thereby, the invariant that the TT and/or BB blocks contain the correct aggregate, may be preserved. The bottom-bottom element may contain the aggregate D for the key “6”. The TB and BT elements in this case can contain arbitrary values, since the actual aggregate is stored in the top-top value. This is illustrated in the figure by the asterixis. In examples where the TT and BB keys do not match the TB and BT keys, the TB and/or BT aggregate values can contain aggregates. In particular, if the TB and BT keys match each other but not the TT or BB keys, then the aggregate can be written to the TB element, to the BT element, or both.

In particular, one way of implementing the conquer step while preserving the above-discussed invariants, is illustrated in the pseudocode below. The respective operations of this pseudocode can be implemented using existing techniques for multi-party computation as known per se. As in other examples, values that are shown as italic may be secret values, e.g., secret shares, of the MPC. Expression a?b: c equals b if the condition a is satisfied and c otherwise and can e.g. be computed under MPC as c+a·(b−c).

In this particular example, the top-bottom and bottom-top elements of the resulting block are aggregated, and then the TT, TB, BT, and BB aggregate values AV are selectively overwritten to preserve the discussed invariants. In this example, interestingly, the aggregate values AV that contain the aggregations for the respective keys, may correspond to the result indicators of the pseudocode example of FIG. 5. It is noted that the keys are not used; only precomputation data derived from them.

```
def aggregate(preprocessing_data, values)
  for level = 0, 1, 2, ...; blocksize = 2, 4, 8, ...
    for block = 0, 1, ... // tt, tb, bt, bt: indices of top-top, top-bottom, ... elements
      agg = values[tb] ⊕ values[bt] // ⊕: aggregation operation
      values[tb] = tb_eq_bt[level][block] ? agg : values[tb]
      values[bt] = tb_eq_bt[level][block] ? agg : values[bt]
      values[tt] = tt_eq_tb[level][block] ? values[tb] : values [tt]
      values[bb] = bt_eq_bb[level][block] ? values[bt] : values[bb]
  return values
```

FIG. 7 shows a detailed, yet non-limiting, example of how to apply a duplication to values using secure multi-party computation. The duplication may take as input a set of values, ordered such that matching keys are adjacent in the ordering. For example, the figure shows keys K, 730. There are five keys labelled “4”, followed by two keys labelled “5”, followed by one key labelled “6”. In this example, the corresponding values are duplicated in-place. Namely, duplicate values DV, 750, may be determined such that for a group of matching values, one of the input values is duplicated to the other values of the group. For example, for the group of “4”s, the corresponding duplicate values DV output by the duplication, may be all the same and equal to one of the input values with key 4″, and similarly for the other groups of values with matching keys. As before, the values that are shown in the figure may be secret values of the MPC.

As discussed e.g. with respect to FIG. 4, also duplication may be performed according to a divide-and-conquer approach. This figure illustrates the conquer step Conq, 700. With reference to FIG. 4, the figure illustrates how the duplicate values DV of set b=0, 420, may be processed by conquer step Conq such that duplication can afterwards be applied to the respective subsets b=0, 410 and b=1, 411.

To this end, conquer step Conq may be configured such that, if the final key of the first subset 410 matches the first key of the second subset 411, the duplicate value DV corresponding to that set of keys is duplicated such that both the first subset 410 and the second subset 411 comprises the value. E.g., in the example illustrated in the figure, prior to the conquer step Conq, the top-top element of block 420 represents the value “X” to be duplicated to the other values with key “4”. The conquer step in this example duplicates the value “X” to the top-bottom (TB) and bottom-top (BT) positions of block 420, corresponding to the bottom-bottom and top-top positions of blocks 410 and 411, respective. Since subblock 410, 411 now both comprise the value “X” to be duplicated, duplication may now be separately applied to the respective sub-blocks.

In particular, as also illustrated in the figure, the conquer step Conq may act only on the top-top (TT), top-bottom (TB), bottom-top (BT), and bottom-bottom (BB) elements of set of duplicate values DV of the block. In particular, the conquer step may duplicate the TT and/or BB elements to the TT and/or TB and/or BT and/or BB elements, depending on which of the corresponding keys match. The information about matching keys may be obtained as precomputation data, but can also be computed during the duplication.

As a consequence of acting only on the TT, TB, BT, and/or BB elements, the conquer step may be implemented efficiently, in particular in rounds with large blocks. For example, value “Y”, corresponding to key “5”, may be untouched by the conquer step Conq at this level since this value is not at a TT, TB, BT, or BB location. This value may be operated on further down in the divide-and-conquer, however.

In order for the conquer step Conq to act only on the TT, TB, BT, and BB elements, the duplication operation may be configured to operate on a block of values such that if the first key and the final key of the block do not match, then the first value and the final value of the set are the values that are duplicated by the duplication to their respective other keys. For example, in block 420, the first key “4” and final key “6” do not match. Accordingly, top-top value “X” and bottom-bottom value “Z” may be duplicated. The same may recursively hold for sub-block block 411: the first key “4” and the final key “6” do not match, so the top-top and bottom-bottom value may be duplicated. Accordingly, the conquer step Conq may aggregate the top-top element “X” of block 420 to the top-top element of block 411 such that this element may be subsequently duplicated by the divide-and-conquer. The bottom-bottom element “Z” may be kept such that the divide-and-conquer uses this element as the element-to-be-duplicated for key “6”.

The conquer step Conq may be further configured to operate such that, if the first key and the final key of a block match, then the first value or the final value of the set is duplicated to the set of values. For example, in block 410, the first and final key are both equal to “4”. Accordingly, the conquer step Conq may be defined such that it sets the top-top and/or bottom-bottom element of block 410 to the value “X” that is to be duplicated. In this example, the conquer step Conq sets both duplicate values DV to be equal to the value “X” to be duplicated.

The conquer step Conq may be implemented as described above in a number of different ways. For example, in case the top-top and bottom-bottom keys of a block match, then it is possible to configure the aggregation such that the top-top value is duplicated, or such that the bottom-bottom value is duplicated. Some implementations of the conquer step Conq may assume that, before the duplication, duplicate values DV that are not duplicated, are set to zero. In other cases, this is not necessary, however.

Generally, which element is duplicated may be indicated by result indicators comprised in precomputation data, as discussed with respect to FIG. 5. It is preferred that the elements to which an aggregation operation aggregates values, as discussed with respect to FIG. 6, are the same as the elements that are duplicated by a duplication operation as described with respect to this figure. This allows to combine the duplication and aggregation. For example, it is possible to determine respective group sizes for respective keys by defining a set of values for the keys to be all equal to one; aggregating these values; and then duplicating the aggregation result.

The following pseudocode illustrates an example implementation of duplication. In this example, the TT, TB, BT, and BB duplication values DV are selectively duplicated according to a particular order according to match indicators tt_eq_tb, tb_eq_bt, bt_eq_bb, tb_eq_bt. In this example, interestingly, the values that are duplicated may correspond to the result indicators of the pseudocode example of FIG. 5. Values in italic may be secret. Also here, the keys are not directly used, and accordingly, at the time of duplicating, access to the set of keys is not needed.

```
def duplicate(preprocessing_data, values)
  for level = ..., 2, 1, 0; blocksize = ..., 8, 4, 2
    for block = 0, 1, ... // tt, tb, bt, bt: indices of top-top, top-bottom, ... elements
      values[tb] = tt_eq_tb[level][block] ? values[tt] : values[tb]
      values[bt] = tb_eq_bt[level][block] ? values[tb] : values[bt]
      values[bt] = bt_eq_bb[level][block] ? values[bb] : values[bt]
      values[tb] = tb_eq_bt[level][block] ? values[bt] : values[tb]
  return values
```

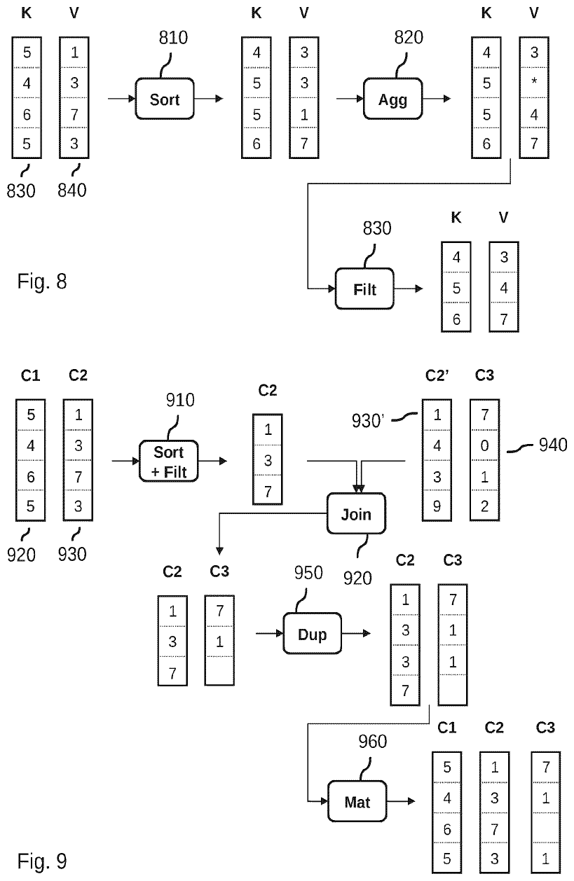

FIG. 8 shows a detailed, yet non-limiting, example of how to aggregate a set of values according to a set of corresponding keys, using multi-party computation. The figure shows a set of keys K, 830, with corresponding values V, 840. In this example, the keys K are not initially ordered such that matching keys are adjacent. Again, due to the use of multi-party computation, the cryptographic devices performing the aggregation, may not see the actual values that the aggregation is performed on.

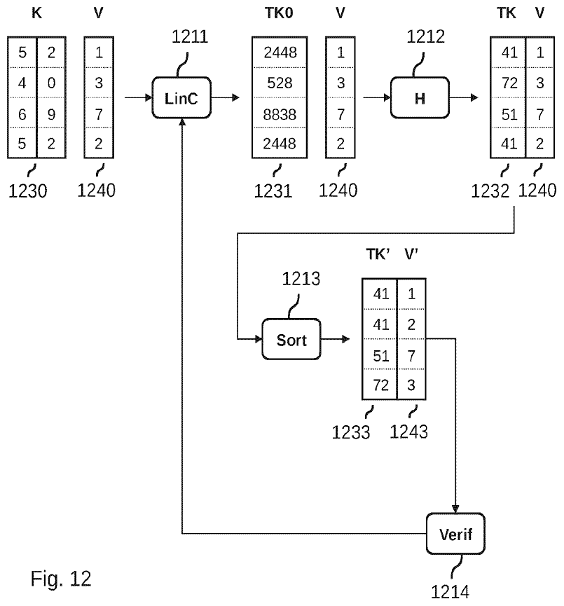

To aggregate values V according to keys K, the values may first be re-ordered such that matching keys are adjacent. In particular, as shown in the figure, this can be done by performing a sorting operation Sort, 810 to sort the keys K and values V according to the keys K. The sorting may be applied according to known techniques, e.g., as discussed in the reference “Secure Multi-Party Sorting and Applications”. It is also possible to first transform the keys K to a smaller range and then order them in the smaller range, as discussed with more detail with respect to FIG. 12.

Next, aggregation Agg, 820 may be applied to the sorted values V, as discussed e.g. with respect to FIG. 6. As illustrated, for a set of matching keys, an aggregate value may be determined that aggregates the values corresponding to the matching keys. For example, the aggregation operation may be the sum. In this example, keys 4 and 6 are unique, so the sum corresponds to the respective values, 3, and 7. The two values 1 and 3 with key 5 are aggregated to an aggregate value 4=3+1, in this example, the third value resulting from aggregation operation Agg.

The values resulting from aggregation Agg may optionally be filtered, in a filtering operation Filt, 830, such that only those aggregate values remain that actually represent an aggregation. In the example shown, out of the two aggregate values for key “5”, the top one is filtered out and the bottom one remains. The filtering can be performed for example based on result indicators comprised in precomputation data. The filtering Filt can be implemented in various ways. One possibility is to randomly permute the keys K and values V under MPC; open the permuted result indicators; and selecting the indicated permuted values V. Another possibility is to zero out values V that do not represent aggregations, optionally after applying a random permutation.

Interestingly, it is also possible to perform the filtering Filt such that the sorted order of the keys is preserved. This can be done based on computing a target index for a respective value under MPC. In particular, for a respective value V representing an aggregation, the target index for the value according to the sorted order of the keys may be determined as the sum of the result indicators up to that value. These target indices can for example be randomly permuted together with the keys, the aggregate values, and the result indicators. The permuted result indicators and target indices can be opened, and can be used to re-arrange the permuted keys and aggregate values appropriately under the MPC.

A particularly beneficial way of implementing the sorting Sort of the values V, or of otherwise arranging the values V such that matching keys are adjacent, is by applying a secret permutation σ to the values V. Such a secret permutation can be represented in various ways as is known per se, e.g., as control bits of one or more Waksman permutation networks. The secret permutation can be comprised in precomputation data, for example, and provided by an input party that inputs the keys K, or computed using multi-party computation (either before or during the aggregation).

The latter can be done for example by having one or more first cryptographic devices input a random permutation π to the MPC, e.g., in the form of respective target indices for respective source elements. The permutation π may be sorted along with the keys K to obtain a sorting σ(π) of the permutation π according to the sorting permutation σ. This sorting σ(π) may be opened to one or more further cryptographic devices. A secret representation of sorting permutation σ may be obtained based on the permutation π and the sorting σ(π) of this permutation. The sorting permutation σ may be applied by applying permutations that are based on π and based on σ(π). In particular, the sorting may represent permutation π·σ⁻¹. The sorting permutation σ may be applied by first applying the permutation (π·σ⁻¹)⁻¹=σ·π⁻¹, e.g., as input by the further cryptographic devices; and then applying the permutation π, e.g., as input by the first cryptographic devices. Similarly, the inverse sorting permutation σ⁻¹ may be applied by first applying π⁻¹ then applying π·σ⁻¹.

The following is an example pseudocode implementation of sorting Sort, aggregating Agg, and filtering Filt, to obtain filtered keys and values representing an aggregation of values V according to keys K. Values in italic may be secret.

def groupby(keys, values):

| | |
|---|---|
| sorted_keys, perm = sort(keys) | // sort keys K |

| | |
|---|---|
| sorted_values = permute(perm, values) | // sort values V according to sorting of K |

preprocessing_data = preprocess(keys)

| | |
|---|---|
| aggregated_values = aggregate(preprocessing_data, sorted_values) | // cf. Fig. 6 |

```
  filtered_keys = filter(preprocessing_data.results, sorted_keys)
  filtered_agg_values = filter(preprocessing_data.results, aggregated_values)
```

| | |
|---|---|
| return filtered_keys, filtered_agg_values | // return filtered keys + aggregated values |

FIG. 9 shows a detailed, yet non-limiting, example of how to perform a merge of tables using multi-party computation. As in earlier examples, the figure shows the values on which the operation is performed, but due to the use of MPC, the cryptographic devices carrying out the computation typically do not learn these values.

The figure shows a first table comprising at least two columns C1, 920 and C2, 930; and a second table comprising at least two columns C2′, 930′ and C3, 940. This example illustrates a merge, also referred to as a join, between the first table and the second column, using join columns C2 and C2′, respectively. Here, column C2 may contain duplicate values, e.g., values that for the purposes of the merge should be matched to the same value of column C2′. The figure illustrates that column C2 contains the value “3” twice. This example illustrates how such a merge with non-unique values can be performed by using the duplication techniques described herein combined with a join on unique values. Such a unique join is known for example from S. Laur et al., “From oblivious AES to efficient and secure database join in the multiparty setting”.

This particular example illustrates a “left join”, where respective rows of the left table C1, C2 are matched to zero or more rows of the right table. The resulting table may have the same number of rows as the left table, optionally in the same order as the left table. However, the techniques can be generalized to perform other types of joins, including right joins and inner joins, as well.

To perform the join, the column C2 containing the non-unique keys may be sorted (or otherwise ordered according to matching values) and filtered Sort+Filt, 910, to obtain the set of unique values of the column. This can be done by applying the sorting 810 and filtering 830 of FIG. 8 to the keys only without values. Next, a unique join Join, 920, may be applied to merge unique values of column C2 with table C2′, C3. As illustrated in the figure, the join Join may associate respective unique key values of column C2, to respective values for the non-key column(s) C3 of the second table. In this example, the unique values “1” and “3” of the key column C2 have an associated value “7” and “1” from column C3, but the unique value “7” does not. In such a case, a missing value indicator 1 may be inserted.

Given the result of the unique join Join, a duplication Dup, 950, may be applied, e.g., according to FIG. 7. The duplication may duplicate the matched values coming from the column C3, such that they match the sorted non-unique values of the column C2. For example, the non-unique values of column C2, in sorted form, are “1”, “3”, “3”, and “7”. The duplication may result in the value “1” of column C3 corresponding to the join key value “3” from column C2 being duplicated according to the number of times this value occurs in column C2, in this case, two times. This same process may be repeated for any other columns of the second table C2′, C3 that are to be joined.

Finally, a matching Mat, 960, may be performed to arrange the non-key column(s) C1 of the first table; the join column(s) C2; and the duplicated non-key column(s) C3 according to the same ordering. In this example, the duplicated non-key column(s) C3 of the second table is re-arranged to match it with the original ordering of table C1, C2. This is done by applying the sorting of operation 910 in the inverse direction, e.g., as discussed with respect to FIG. 8. It is also possible, for example, to re-arrange the non-key column(s) C1 of the first table according to the sorted ordering resulting from duplication Dup, e.g., by applying the sorting of operation 910 to the non-key column(s) C1, e.g., as discussed with respect to FIG. 8.

The following is an example pseudocode implementation of the merge operation illustrated with respect to this figure. As in earlier examples, values in italic may be secret.

def left_join(table1, table2):

| | |
|---|---|
| sorted_keys, perm = sort(keys) | // sort |

preprocessing_data = preprocess(keys)

| | |
|---|---|
| filtered_keys = filter(preprocessing_data.results, sorted_keys) | // filter |
| _, table2_joined = unique_left_join(filtered_keys, table2) | // unique join |
| return table1, inverse_permute(perm, duplicate(preprocessing_data, | // match |

inverse_filter(preprocessing_data.results, table2_joined)

FIG. 12 shows a detailed, yet non-limiting, example of ordering values. In this example, a set of values may be ordered according to a set of keys by transforming the keys to a smaller range, and performing the ordering in this smaller range. This means that the number of possible values of a transformed key is smaller than the number of possible values of the key itself.

In particular, the techniques described with respect to this figure may be applied in the case where keys are made up of multiple subkeys. This can apply for example when a key is a combination of multiple columns of a table, and/or when a key is textual, e.g., with subkeys corresponding to individual characters of the text. For example, a textual key with a maximum length of N may be represented by N+1 values: a length value and N values corresponding to the characters, with a fixed value being used for characters beyond the length of the text. However, the described techniques also apply when a key does not comprise subkeys but is still transformed to a transformed key from a smaller range.

By way of illustration, the figure shows keys K, 1230, with a respective key comprising two subkeys. This is for illustrative purposes only; the number of subkeys per key can be much larger, e.g., at least 5, at least 10, or at least 100. A subkey may be represented as a secret value of the multi-party computation, e.g., as a single secret share. Also shown are corresponding values V, 1240, as in FIG. 9.

In this example, to transform keys K, first, a linear combination LinC, 1211 is applied. In this example, the operation is a linear combination 132*x1+894*x2. The operation may result in a single value TK0, 1231, representing a respective key K.

For example, the computation devices may select random linear coefficients from a sufficiently large range, and compute the linear combination using these random linear coefficients. Interestingly, if these coefficients are not known to the parties that provide the keys K, then the use of a linear combination may lead to a small probability of collisions, e.g., approximately 1/|F| if the computation is over a mathematical field F. For example, the size of the coefficients may be selected, e.g., based on the number of keys K, such that the probability of collisions is small, e.g., at most 2\hat{ }-20, at most 2\hat{ }-30, or at most 2\hat{ }-40. For example, the linear combination may be computed modulo a modulus, e.g., a prime modulus, where the modulus is at least 60 bits, at least 80 bits, or at least 100 bits.

Interestingly, when using a linear combination, a small collision probability may be achieved while still leading to a large range reduction, since multiple input values, e.g., multiple field elements, may be transformed to a single field element. This means that just using a linear combination LinC can suffice, e.g., a hash function is not needed.

It is also possible to use coefficients that always map different inputs to different outputs, e.g., to map digits d0, d1 to 10*d0+d1. Although this may not reduce the size of the range, it can be useful in combination with a hash function as discussed below.

Further shown in this example is a hash function H, 1212, that is optionally applied to the linear combination TK0, resulting in the transformed value TK, 1232. The hash function H may be a cryptographic hash function. The hash function may have a smaller range than the keys K and the linear combinations TK0. For example, the range of the hash function may be selected such that the probability of collision, when all input keys are different, is non-negligible, e.g., at most or at least 1%, at most or at least 5%, at most or at least 25%, or at most or at least 50%. Although the probability of collision generally depends on the number of different input keys, interestingly, by the use of a hash function, it may not depend in a predictable way on the values of the input keys themselves. Thus, the hash function may allow, from the point of view of privacy, the use of a non-negligible collision probability.

In general, various hash functions H may be used. The hash H may be a keyed hash, e.g., with randomly generated parameters. Implementations of various hash functions under MPC are known per se. For example, the MiMC hash may be used as described in Cryptology ePrint archive 2016/492, “MiMC: Efficient Encryption and Cryptographic Hashing with Minimal Multiplicative Complexity”, M. Albrecht et al., The linear combination LinC may be considered part of the hash function, e.g., in the current example, LinC and H may together be considered to form a hash that is applied to the keys K. When seen as a whole, the hash may be parameterized by one or more parameters that are unknown to the cryptographic devices, e.g., linear combination coefficients of the linear combination and/or a key of the hash function. This makes it harder for the cryptographic devices to derive information from whether or not there is a collision in the hash function.

For example, the hash may be evaluated under the same modulus as the linear combination LinC, and then a modulo reduction to a target modulus may be applied to reduce the range size. To perform the modulo reduction, for example, parties may input additive secret shares of the hash output in a large field; add the additive share; and modulo-reduce the result in the larger field, e.g., by using a comparison to the target modulus. The modulo-reduced value may be converted to a sharing under a smaller modulus to obtain the translated key TK. For example, a translated key TK may be obtained that is a value of at most 20, at most 40, or at most 60 bits. The translated key TK may be secret-shared under a secret-sharing modulus of at most 64 bits or at most 128 bits, For example, when using transformed keys TK with a maximum of 33 bits, it is possible to perform the presently described ordering with up to around 100000 unique keys K with a sufficient probability of success.

As a concrete example, the output range of the hash function may be selected based on the number of values q as follows. For q random values, the collision probability over n bits may be bounded by q\hat{ }2/2\hat{ }(n+1). When q=2\hat{ }b, this gives a probability of 1/2\hat{ }(n−2b+1). Choosing n=2b+3 may accordingly result in 1/2\hat{ }4, around 6%. Accordingly, a target modulus 2\hat{ }n, e.g., n-bit hashes, may be used. It may be noted that for r keys this error probability is a worst-case error probability for the case q=r, which is when there are no duplicate keys.

Concerning the effect of using the hash to make collision probabilities independent of the underlying data, the following example may be considered. Consider two multi-value inputs for which only the first value x_1 differs. In this case, if a linear combination modulo p is used with random coefficients, this linear combination may collide when c_1=0. While this has the expected probability of 1/p, this condition is the same for all such inputs. If the whole data only vary in x_1, this means that all collisions are fully correlated, hence the probability for a collision remains at 1/p instead of the expected one around r\hat{ }2/p for r rows. Therefore, in this example, if the linear combination has a too small range, the difference between these probabilities r\hat{ }2/p and 1/p may be non-negligible, and the occurrence of collisions may leak information leaked about the input keys. Interestingly, however, when using a linear combination over a large range and then a hash to reduce the range size, this leakage does not occur since the collisions may be independent from the shape of the input data.

Generally, various alternatives are possible to obtain the transformed key TK. In particular, it is possible to use the linear combination LinC without using the hash H, or to use the hash H without using the linear combination LinC.

Further shown in the figure is a sorting operation Sort, 1213, in which an ordering the values V may be determined according to the transformed keys TK. As also discussed elsewhere, various techniques for sorting under multi-party computation are known per se and can be applied in this step. The result may be a re-ordering V′, 1243, of the values V such that the re-ordered transformed keys TK′, 1233, are sorted, or at least are ordered such that equal transformed keys are adjacent to each other in the ordering.

Further shown is a verification operation Verif, 1214, to verify that the values V′ are ordered such that matching keys K are adjacent in the ordering. This verification operation may be applied in cases where the transformation of the keys has a non-negligible probability of introducing collisions. In other cases, e.g., where only a linear combination is applied, and the linear combination has a small enough probability of collisions, verification operation Verif may not be needed.

Interestingly, the verification may be performed relatively efficiently under MPC. To perform the verification Verif, pairwise comparisons may be made of adjacent transformed keys TK′, e.g., using a multi-party computation protocol for comparison as is known per se. Interestingly, if the verification succeeds, then these pairwise comparisons may be used as the pairwise comparisons that are used to compute match indicators, as also discussed elsewhere in this specification. It is noted that the verification is performed on the keys K, so it may be performed prior to actually re-ordering the values V. In particular, if the verification Verif fails, then the actual re-ordering of the values may be skipped.

For a pair of keys K ordered according to the sorting of the transformed keys TK′, it may be verified that the product of the comparison result and a difference between the adjacent keys is zero. Namely, this product may be zero only if the comparison result is zero, so the adjacent keys are different; or if the difference is zero, so the adjacent keys are equal. Both may indicate that the ordering is correct for these adjacent keys. For a key with multiple subkeys, it may be verified that respective products between the comparisons and the differences between respective subkey values for the adjacent keys, are all zero. It is also possible to base the comparison on the transformed keys TK0, since these are very likely to preserve equality. In any case, all products for all adjacent keys being zero may imply that the keys are correctly ordered. Such a zero test may be implemented as an inner product comprising the respective products multiplied by respective known random linear coefficients, and can accordingly be implemented under multi-party computation very efficiently.

The verification result, e.g., a value indicating whether or not the values V′ are ordered according to the keys K, may be opened to the parties performing the multi-party computation. Interestingly, as discussed, this may not leak information about the underlying keys K apart from the total number of different keys.

As illustrated in the figure, based on the verification, part or all of the computation of the transformed keys TK can optionally be repeated, e.g., the hashing H and optionally also the linear combination LinC may be repeated, e.g., with a different key for the (in this case, keyed) hash and/or the linear combination such that different transformed keys TK may be obtained. For example, a given number of retries may be performed before an error is raised. The number of retries may be selected such that the expected probability of failure is negligible. It is also possible to directly raise an error without retrying.

Generally, the techniques discussed with respect to this figure allow to efficiently determine an ordering under MPC such that matching input keys K are adjacent, in other words, an ordering that groups input keys K into groups of matching (e.g., equal) keys. Determining such an ordering is of independent interest regardless of whether it is used in combination with other techniques described in this specification. In particular, the aggregation techniques of K. Jonsson et al., “Secure Multi-Party Sorting and Applications”, are based on sorting key-value pairs; this sorting can be replaced by an ordering of the key-value pairs as described with respect to this figure. Accordingly, specifically envisaged are a cryptographic system for, and a cryptographic method of, determining an ordering of a set of values V under multi-party computation such that corresponding matching keys K are adjacent, where the values V and keys K can optionally be the same.

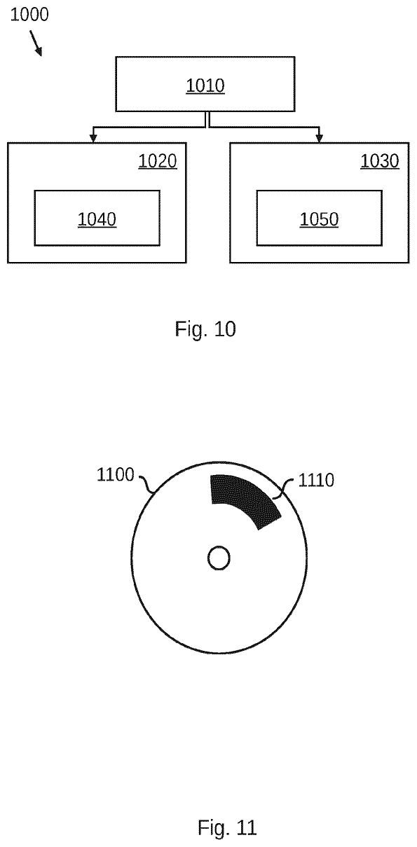

FIG. 10 shows a block-diagram of a cryptographic method 1000 of performing an aggregation of a set of values according to a corresponding set of keys and/or for applying a duplication to the set of values according to the set of keys.

The aggregation and/or duplication may be performed by a cryptographic device. The aggregation and/or duplication may be performed in a privacy-preserving way as a cryptographic secure multi-party computation between multiple cryptographic devices comprising the cryptographic device. For example, the cryptographic device can be device 100 of FIG. 1 or device 200 of FIG. 2. However, this is not a limitation, in that the method 1000 may also be performed using another system, apparatus or device. The method 1000 may further comprise the other cryptographic devices carrying out the secure multi-party computation. For example, the method 1000 may be carried out by a cryptographic system, e.g., cryptographic system 010 of FIG. 3. The method 1000 may be computer-implemented.

The method 1000 may comprise, in an operation titled “OBTAIN VALUES”, obtaining 1010 private representations of the respective values to be aggregated and/or duplicated. The respective values may be ordered such that matching keys are adjacent in the ordering.

The method 1000 may comprise, in an operation titled “AGGREGATE”, applying 1010 the aggregation to the respective values. The aggregation 1020 may comprise, in an operation titled “AGGREGATE SUBSETS OF ADJACENT VALUES”, aggregating adjacent first and second subsets of the set of values.

Instead of or in addition to the aggregating 1020, the method 1000 may comprise, in an operation titled “DUPLICATE”, applying 1030 the duplication to the respective values. The duplication 1030 may comprise, in an operation titled “DUPLICATE SUBSETS OF ADJACENT VALUES”, duplicating 1040 adjacent first and second subsets of the set of values.

It will be appreciated that, in general, the operations of method 1000 of FIG. 10 may be performed in any suitable order, e.g., consecutively, simultaneously, or a combination thereof, subject to, where applicable, a particular order being necessitated, e.g., by input/output relations.

The method(s) may be implemented on a computer as a computer implemented method, as dedicated hardware, or as a combination of both. As also illustrated in FIG. 11, instructions for the computer, e.g., executable code, may be stored on a computer readable medium 1100, e.g., in the form of a series 1110 of machine-readable physical marks and/or as a series of elements having different electrical, e.g., magnetic, or optical properties or values. The medium 1100 may be transitory or non-transitory. Examples of computer readable mediums include memory devices, optical storage devices, integrated circuits, servers, online software, etc. FIG. 11 shows an optical disc 1100.

The instructions may be instructions for one or more particular devices of the cryptographic system. In particular, the instructions may comprise instructions for a cryptographic device to perform an aggregation and/or a duplication as described herein.

Instead of or in addition to containing instructions, the medium 1100 may comprise data representing precomputation data for use as described herein. The precomputation data may comprise match indicator(s), result indicator(s), and/or permutations as described herein. The data may be secret, e.g., the data may represent the secret-shares for one or more cryptographic devices performing the MPC.

Examples, embodiments or optional features, whether indicated as non-limiting or not, are not to be understood as limiting the invention as claimed.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or stages other than those stated in a claim. The article “a” or “an” preceding an element does not exclude the presence of a plurality of such elements. Expressions such as “at least one of” when preceding a list or group of elements represent a selection of all or of any subset of elements from the list or group. For example, the expression, “at least one of A, B, and C” should be understood as including only A, only B, only C, both A and B, both A and C, both B and C, or all of A, B, and C. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A cryptographic system for performing an aggregation of a set of values according to a corresponding set of keys and according to an aggregation operation, wherein the aggregation is performed in a privacy-preserving way as a cryptographic secure multi-party computation between multiple cryptographic devices, wherein a cryptographic device is configured to:
obtain the respective values as secret values of the multi-party computation, wherein the respective values are ordered such that matching keys are adjacent in the ordering;
aggregate the set of respective values to compute the respective aggregate values under the multi-party computation, wherein, for a set of multiple matching keys, at least one of the corresponding aggregate values represents an aggregation according to the aggregation operation of the set of values corresponding to the set of matching keys, wherein the aggregating is performed by:
dividing the set of values into multiple subsets of adjacent values;
aggregating adjacent first and second subsets;
combining the aggregated values of the first and second subset by, if the final key of the first subset matches the first key of the second subset, combining aggregate values for the final key and the first key.

2. The system of claim 1, wherein the cryptographic device is configured to perform the aggregation of a set of values such that,
if the first key and the final key of the set do not match, then the first aggregate value and the final aggregate value of the set represent the aggregations for the first and final keys; and/or
if all keys of the set match, then the first and/or final aggregate value represents the aggregation of the set of values.

3. The system of claim 2, wherein, if all keys of the set match, the first and final aggregate value both represent the aggregation of the set of values.

4. The system of claim 1, wherein the cryptographic device is configured to combine the first and/or final aggregate value of the first subset and the first and/or final aggregate value of the second subset.

5. The system of claim 1, wherein the cryptographic device is further configured to sort the respective values under the secure multi-party computation to order the values such that the matching keys are adjacent in the ordering.

6. The system of claim 1, wherein the cryptographic device is configured to order the values such that the matching keys are adjacent in the ordering by:
transforming a respective key into a respective transformed key, wherein the range of the respective transformed key is smaller than the range of the respective key;
ordering the values according to the respective transformed keys.

7. The system of claim 6, wherein the cryptographic device is configured to transform the respective key into the respective transformed key by:
computing a linear combination of multiple subkeys comprised in the respective-key, and/or
applying a hash function, wherein the cryptographic device is further configured to verify that the values are ordered such that the matching keys are adjacent in the ordering.

8. The system of claim 1, wherein the cryptographic device is configured to obtain and use precomputation data, wherein the precomputation data is determined before performing the aggregation, and wherein the precomputation data comprises a match indicator indicating if the final key of the first subset matches the first key of the second subset.

9. The system of claim 8, wherein the cryptographic device is configured to compute a match indicator, indicating if a final key of a first subset matches a first key of a second subset, by performing pairwise comparisons of adjacent keys and combining the pairwise comparisons.

10. The system of claim 8, wherein the precomputation data further comprises result indicators indicating which aggregate values represent an aggregation, and wherein the cryptographic system is further configured to filter the aggregate values according to the result indicators.

11. The system of claim 8, wherein the precomputation data further comprises data representing a permutation to order the respective values according to the ordering.

12. A cryptographic system for applying a duplication to a set of values according to a set of keys, wherein the duplication is performed in a privacy-preserving way as a cryptographic secure multi-party computation between multiple cryptographic devices, wherein a cryptographic device is configured to:
obtain the respective values as secret values of the multi-party computation, wherein the respective values are ordered such that matching keys are adjacent in the ordering;
apply the duplication to the set of respective values under the multi-party computation, wherein for a set of multiple matching keys, a value corresponding to a matching key is duplicated to the values corresponding to the other matching keys, wherein the duplicating is performed by:
dividing the set of values into multiple subsets of adjacent values;
for a first and second adjacent subset, if the final key of the first subset matches the first key of the second subset, duplicating the value corresponding to their set of keys such that both the first and the second subset comprise the duplicated value;
applying the duplication to the first and second subsets of values.

13. The system of claim 12, wherein the duplication is applied to a set of values such that,
if the first key and the final key of the set do not match, then the first value and the final value of the set are duplicated to their respective other keys;
if the first key and the final key of the set match, then the first value or the final value of the set is duplicated to the set of values.

14. The system of claim 12, wherein the system is configured to perform a merge of a first table and a second table on a first column of the first table and a second column of the second table, wherein the first column contains duplicates, and wherein performing the join comprises duplicating values from a further column of the second table according to the first column of the first table.

15. A cryptographic device for use in the system according to claim 1, wherein the cryptographic device is for performing an aggregation of a set of values according to a corresponding set of keys and/or for applying a duplication to the set of values according to the set of keys, wherein the aggregation and/or duplication is performed in a privacy-preserving way as a cryptographic secure multi-party computation between multiple cryptographic devices comprising the cryptographic device, wherein the cryptographic device comprises:
a communication interface configured for communication with at least one further cryptographic device of the cryptographic system.
a processor subsystem configured to:
obtain the respective values as secret values of the multi-party computation, wherein the respective values are ordered such that matching keys are adjacent in the ordering;
apply the aggregation and/or the duplication to the respective values, wherein the aggregation and/or the duplication comprises aggregating and/or duplicating adjacent first and second subsets of the set of values.

16. A cryptographic method of performing an aggregation of a set of values according to a corresponding set of keys and/or for applying a duplication to the set of values according to the set of keys, wherein the aggregation and/or duplication is performed in a privacy-preserving way by a cryptographic device as a cryptographic secure multi-party computation between multiple cryptographic devices comprising the cryptographic device, wherein the cryptographic method comprises:
obtaining the respective values as secret values of the multi-party computation, wherein the respective values are ordered such that matching keys are adjacent in the ordering;
applying the aggregation and/or the duplication to the respective values, wherein the aggregation and/or the duplication comprises aggregating and/or duplicating adjacent first and second subsets of the set of values.

17. A non-transitory computer-readable medium comprising data representing:
instructions which, when executed by a processor system, cause the processor system to perform the cryptographic method of claim 16; and/or
precomputation data for use in the cryptographic method of claim 16, wherein the precomputation data comprises private representations for one or more cryptographic devices of: one or more match indicators indicating if a respective final key of a first subset matches a respective key of a second subset; one or more result indicators indicating which aggregate values represent an aggregation; and/or a permutation to order respective values according to an ordering of respective keys.
